(19) United States
(12) Patent Application Publication
(10) Pub. No.: US 2024/0336801 A1
(43) Pub. Date: Oct. 10, 2024

(54) ELECTRICALLY INSULATED WIRES AND CABLES

(71) Applicant: DUPONT ELECTRONICS, INC., WILMINGTON, DE (US)

(72) Inventors: SHAWN A. FILLIBEN, PALM COAST, FL (US); MICHAEL F. MULZER, CIRCLEVILLE, OH (US); JEREMY MICHAEL RAYBURN, CIRCLEVILLE, OH (US)

(21) Appl. No.: 18/618,103

(22) Filed: Mar. 27, 2024

Related U.S. Application Data
(60) Provisional application No. 63/494,210, filed on Apr. 4, 2023.

(51) Int. Cl. C09D 127/18; C09D 133/24; H01B 1/02; H01B 3/30; H01B 3/44

(52) U.S. Cl. CPC C09D 127/18; C09D 133/24; H01B 1/026; H01B 3/306; H01B 3/445

(57) ABSTRACT

In a first aspect, an electrically insulated wire or cable includes a stranded conductor, an inner wrap around the stranded conductor and an outer wrap around the inner wrap. The inner wrap includes a base film tape, wherein the base film tape includes a polyimide film having an electrically insulative, corona resistant composite filler, a first fluoropolymer coating adhered to a first side of the polyimide film and a second fluoropolymer coating adhered to a second side of the polyimide film. The outer wrap includes a fluoropolymer tape. The electrically insulated wire or cable has a void space in a range of from 2 to 43%, based on the total space available inside the inner wrap.

### FIELD OF DISCLOSURE

The field of this disclosure is electrically insulated wires and cables.

### BACKGROUND OF THE DISCLOSURE

Modern aerospace applications are demanding ever-increasing performance for electrically insulated wires and cables. As systems are designed for operation at higher voltages over long periods of time, the need for corona resistant films arises. These films, when used as wire insulation material, need to maintain both good electrical properties (e.g., voltage endurance) and mechanical properties (e.g., scrape abrasion and dynamic cut through). Typically, a wire will be bent into various shapes or directions, and the corona resistant film covering the wire or cable needs to have the ability to do the same. The addition of filler to corona resistant films can negatively impact their mechanical properties, and the films can become more brittle (lower tensile strength and elongation).

Corona-resistant films have previously been used in magnet wire constructions for traction motors, i.e., wire consisting of a singular copper strand, the surface of which is covered with an insulating film material. Because only a single-stranded wire is used, the insulating film is in very close contact to the wire conductor, thus providing a uniform interface throughout the construction, and the resulting construction is essentially free of any substantial void space between the film side facing the wire and the surface of the wire itself. In addition, no significant void space exists under the insulation material since the space under the insulation material is wholly occupied by the conductor. However, in aerospace applications multi-stranded single conductors are preferentially used instead of a single-stranded wire to take advantage of the higher flexibility and lower resistance of such constructions. As can be seen in a cross-section of an insulated multi-stranded wire, covering a multi-stranded single conductor with a film-based insulating material will leave significant amounts of void space inside the resulting construction in contrast to the construction obtained when using a single-stranded wire. The presence of such void space can negatively affect the outcome of performance tests such as PDIV (Partial Discharge Inception Voltage) testing or Voltage Endurance testing. Because of the existence of additional void space inside the film-insulated multi-stranded single conductor, it can be expected that the performance of corona-resistant insulating films typically used in magnet wire constructions would be negatively impacted because the insulation material is simultaneously attacked by corona from two opposing sides instead of just a single side, and thus the function, behavior, and benefit of such corona-resistant insulating films is hard to predict in such a construction.

Crosslinked ethylene-tetrafluoroethylene (XL-ETFE, wherein ETFE is a copolymer of ethylene (E) and tetrafluoroethylene (TFE), such as Tefzel® ETFE) is commonly used as an electrical-cable-jacketing material in aircraft wire insulation because of its resistance to heat, creep, and arc tracking. As compared to polytetrafluoroethylene (PTFE), it exhibits enhanced impact strength, abrasion, and cut-through resistance. ETFE is resistant to radiation and exhibits higher mechanical strength than other fluoropolymers and is free from creep issues noticed in incorrectly sintered PTFE. XL-ETFE can be continuously used at 200° C. and exhibits improved tensile strength and anti-aging resistance compared to non-crosslinked ETFE. However, XL-ETFE does not meet flammability criteria in 30+% oxygen (unless additional additives are added), outgases fluorine over time which can cause corrosion of unprotected metals in sealed or confined environments, and is sensitive to degradation from ultraviolet radiation, and is less flexible and more difficult to strip.

In higher voltage applications, performance shortcomings of the insulation material might be overcome by using thicker layers of insulation wrap, but this adds undesirable bulk and weight to the wrapped wire. A need exists for improved electrically insulative, corona resistant films that can endure the demands of higher voltage aerospace applications and can do so while limiting the form factor of the film.

### DETAILED DESCRIPTION

In a first aspect, an electrically insulated wire or cable includes a stranded conductor, an inner wrap around the stranded conductor and an outer wrap around the inner wrap. The inner wrap includes a base film tape, wherein the base film tape includes a polyimide film having an electrically insulative, corona resistant composite filler, a first fluoropolymer coating adhered to a first side of the polyimide film and a second fluoropolymer coating adhered to a second side of the polyimide film. The outer wrap includes a fluoropolymer tape. The electrically insulated wire or cable has a void space in a range of from 2 to 43%, based on the total space available inside the inner wrap.

A polyimide film having an electrically insulative, corona resistant composite filler can be formed from a substantially chemically converted polyimide or a thermally converted polyimide. Polyimide films with electrically insulative, corona resistant composite filler can be made through careful selection of the dianhydride and diamine monomers used for the polyimide backbone. In one embodiment, a polyimide film having a chemically converted polyimide has a more uniform dispersion of corona resistant composite filler compared to a polyimide film having thermally converted polyimide. Additionally, the polyimide film having a chemically converted polyimide has better dielectric strength, tensile strength, elongation and corona resistance compared to a polyimide film having a thermally converted polyimide.

As used herein, the term “substantially chemically converted” means that a polyimide is 75% or more, 80% or more, 85% or more, 90% or more, or 95% or more imidized using a process incorporating conversion chemicals (i.e., catalysts and dehydrating agents) in which a solvated mixture (a polyamic acid casting solution) can be cast or applied onto a support to give a partially imidized gel film, and then heated in an oven, using convective and radiant heat, to remove solvent and complete the imidization. Percent imidization can be measured by comparing a ratio of intensities at 1365 cm⁻¹ (polyimide C—N) relative to 1492 cm⁻¹ (aromatic stretch used as an internal standard) in Attenuated Total Reflectance Fourier Transform Infra-Red (ATR-FTIR) spectroscopy and comparing the ratio to that of a sample prepared with standard curing methods that is defined as being 100% cured.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polyimide films. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

It will be understood that although the terms first, second, third, etc. may be used herein to describe various elements, components, regions, layers and/or sections, these elements, components, regions, layers, and/or sections should not be limited by these terms. These terms are only used to distinguish one element, component, region, layer and/or section from another element, component, region, layer and/or section. Thus, a first element, component, region, layer and/or section could be termed a second element, component, region, layer and/or section without departing from the teachings of the present invention. Similarly, the terms “top” and “bottom” are only relative to each other. It will be appreciated that when an element, component, layer or the like is inverted, what is the “bottom” before being inverted would be the “top” after being inverted, and vice versa. When an element is referred to as being “on” or “disposed on” another element, it means positioning on or below the object portion, but does not essentially mean positioning on the upper side of the object portion based on a gravity direction, and it can be directly on the other element or intervening elements may be present therebetween. In contrast, when an element is referred to as being “directly on” or “disposed directly on” another element, there are no intervening elements present.

Further, it will also be understood that when one element, component, region, layer and/or section is referred to as being “between” two elements, components, regions, layers and/or sections, it can be the only element, component, region, layer and/or section between the two elements, components, regions, layers and/or sections, or one or more intervening elements, components, regions, layers and/or sections may also be present.

### Stranded Conductors

In one embodiment, a stranded conductor can be a high-temperature, multi-stranded conductor wire with individual strands in a range of from 19 to 5000, rated for temperatures up to 260° C. As used herein, the term “stranded conductor” is intended to mean a conductor wire in which multiple strands of uninsulated wires are bundled together to form a single-conductor wire, in contrast to “Litz” wire, in which each strand in a multi-strand is individually insulated. In one embodiment, the individual strands can comprise copper. In one embodiment, copper can include oxygen-free copper. In one embodiment, individual strands of copper can be coated with a metal or metal alloy plating, such as tin, silver, nickel and mixtures and alloys thereof. In one embodiment, a high-strength copper alloy can be used that resists corrosion and oxidation at high temperatures as well as chemicals, alkalis, hydraulic fluids, and fuel. In one embodiment, the size of the multi-stranded conductor wire can be in a range of from AWG (American Wire Gauge) 0000 to AWG 26 (a diameter of the conductor wire ranging from 0.0175 to 0.6050 inches (0.445 to 15.4 mm)). The size of individual strands of a given wire can be in a range of from AWG 24 to AWG 40 (a diameter in a range of from 0.0031 to 0.0201 inches (78.7 to 511 μm)).

Stranded conductor can be manufactured in a variety of configurations, the most common being concentric (true concentric, equilay concentric, unidirectional concentric, and unilay concentric), bunched and rope, wherein concentric is defined as a central strand surrounded by one or more layers of helically strands laid in a geometric pattern. The geometric pattern requires that concentric constructions can only be produced with 7, 19, 37, 61, (etc.) strands or members, following the pattern that each successive layer has 6 more strands than the layer below it. In all types of concentric constructions, the geometric pattern of the strands is consistent for the entire length of the conductor. That is, the central strand, and the strands in each layer remain in their respective positions from the beginning to the end of its length. In one embodiment, a concentric stranded conductor is used.

### Organic Solvents

Useful organic solvents for the synthesis of the polyimides of the present invention are preferably capable of dissolving the polyimide precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), N,N-dimethylacetamide (DMAc), methyl ethyl ketone (MEK), N,N-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and N,N-dimethylacetamide (DMAc).

### Diamines

In one embodiment, any number of suitable diamines can be used for monomers to form the polymer backbone. Aromatic diamines can include fluorinated aromatic diamines, such as 2,2′-bis(trifluoromethyl)benzidine (TFMB), 2,2′-bis-(4-aminophenyl)hexafluoropropane, 4,4′-diamino-2,2′-trifluoromethyldiphenyloxide, 3,3′-diamino-5,5′-trifluoromethyldiphenyloxide, 9,9′-bis(4-aminophenyl)fluorene, 4,4′-trifluoromethyl-2,2′-diaminobiphenyl, 4,4′-oxy-bis[2-trifluoromethyl)benzeneamine](1,2,4-OBABTF), 4,4′-oxy-bis[3-trifluoromethyl)benzeneamine], 4,4′-thiobis[(2-trifluoromethyl)benzeneamine], 4,4′-thiobis[(3-trifluoromethyl)benzeneamine], 4,4′-sulfoxyl-bis[(2-trifluoromethyl)benzeneamine, 4,4′-sulfoxyl-bis[(3-trifluoromethyl)benzeneamine], 4,4′-keto-bis[(2-trifluoromethyl)benzeneamine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenylether; 1,4-(2′-trifluoromethyl-4′,4″-diaminodiphenoxy)benzene, 1,4-bis(4′-aminophenoxy)-2-[(3′,5′-ditrifluoromethyl)phenyl]benzene (6F-amine), 1,4-bis[2′-cyano-3′(“4-amino phenoxy)phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-bis[4(4-aminophenoxy)phenyl]phthalein-3′,5′-bis(trifluoromethyl)anilide (6FADAP) and 3,3′,5,5′-tetrafluoro-4,4′-diamino-diphenylmethane (TFDAM).

Other useful aromatic diamines can include 4,4′-diaminobiphenyl, 4,4″-diaminoterphenyl, 4,4′-diaminobenzanilide (DABA), 4,4′-diaminophenylbenzoate, 4,4′-diaminobenzophenone, 4,4′-diaminodiphenylmethane (MDA), 4,4′-diaminodiphenylsulfide, 4,4′-diaminodiphenylsulfone, 3,3′-diaminodiphenylsulfone, bis[4-(4-aminophenoxy)phenyl]sulfone (BAPS), 4,4′-bis(4-aminophenoxy)biphenyl (BAPB), 4,4′-diaminodiphenylether (ODA), 3,4′-diaminodiphenylether, 4,4′-isopropylidenedianiline, 2,2′-bis(3-aminophenyl)propane, 2,2-bis(4-aminophenyl)propane, 3,3′-dimethyl-4,4′-diaminobiphenyl, 4-aminophenyl-3-aminobenzoate, bis(p-beta-amino-t-butylphenyl)ether, p-bis-2-(2-methyl-4-aminopentyl)benzene. In one embodiment, the diamine is a triamine, such as N,N-bis(4-aminophenyl)-n-butylamine, N,N-bis(4-aminophenyl)methylamine or N,N-bis(4-aminophenyl)aniline.

Other useful aromatic diamines can include 1,2-bis(4-aminophenoxy)benzene, 1,3-bis(4-aminophenoxy)benzene (RODA), 1,2-bis(3-aminophenoxy)benzene, 1,3-bis(3-aminophenoxy)benzene, 1-(4-aminophenoxy)-3-(3-aminophenoxy)benzene, 1,4-bis-(4-aminophenoxy)benzene, 1,4-bis(3-aminophenoxy)benzene, 1-(4-aminophenoxy)-4-(3-aminophenoxy)benzene, 2,2-bis(4-[4-aminophenoxy]phenyl)propane (BAPP), 2,2′-bis(4-phenoxyaniline)isopropylidene.

Other useful aromatic diamines can include p-phenylenediamine (PPD), m-phenylenediamine (MPD), 2,5-dimethyl-1,4-diaminobenzene, 2,5-dimethyl-1,4-phenylenediamine (DPX), 1,4-naphthalenediamine,1,5-naphthalenediamine, 1,5-diaminonaphthalene, m-xylylenediamine, and p-xylylenediamine.

In one embodiment, additional useful diamines for forming the polyimide can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

Other useful additional diamines for forming the polyimide can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro[3.3]heptane), bicyclo[2.2.1]heptane-1,4-diamine, isophoronediamine, and bicyclo[2.2.2]octane-1,4-diamine. Other alicyclic diamines can include cis-1,4-cyclohexanediamine, trans-1,4-cyclohexanediamine, 1,4-bis(aminomethyl)cyclohexane, 4,4′-methylenebis(cyclohexylamine), 4,4′-methylenebis(2-methyl-cyclohexylamine), bis(aminomethyl)norbornane.

### Dianhydrides

In one embodiment, any number of suitable dianhydrides can be used for monomers to form the polymer backbone. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable aromatic dianhydrides include 3,3′,4,4′-biphenyltetracarboxylic dianhydride (BPDA), 2-(3′,4′-dicarboxyphenyl)-5,6-dicarboxybenzimidazole dianhydride, 2-(3′,4′-dicarboxyphenyl)-5,6-dicarboxybenzoxazole dianhydride, 2-(3′,4′-dicarboxyphenyl)-5,6-dicarboxybenzothiazole dianhydride, 2,2′,3,3′-benzophenonetetracarboxylic dianhydride, 2,3,3′,4′-benzophenonetetracarboxylic dianhydride, 3,3′,4,4′-benzophenonetetracarboxylic dianhydride (BTDA), 2,2′,3,3′-biphenyltetracarboxylic dianhydride, 2,3,3′,4′-biphenyltetracarboxylic dianhydride, 4,4′-thio-diphthalic anhydride, bis (3,4-dicarboxyphenyl)sulfone dianhydride, bis(3,4-dicarboxyphenyl)sulfoxide dianhydride (DSDA), bis(3,4-dicarboxyphenyloxadiazole-1,3,4)-p-phenylene dianhydride, bis(3,4-dicarboxyphenyl)-2,5-oxadiazole-1,3,4-dianhydride, bis(3′,4′-dicarboxydiphenylether)-2,5-oxadiazole-1,3,4-dianhydride, 4,4′-oxydiphthalic anhydride (ODPA), bis(3,4-dicarboxyphenyl)thioether dianhydride, bisphenol A dianhydride (BPADA), bisphenol S dianhydride, bis-1,3-isobenzofurandione, 1,4-bis(4,4′-oxyphthalic anhydride)benzene, bis(3,4-dicarboxyphenyl)methane dianhydride, perylene-3,4,9,10-tetracarboxylic dianhydride, 1,3-bis-(4,4′-oxydiphthalic anhydride)benzene, 2,2-bis(3,4-dicarboxyphenyl)propane dianhydride, 4,4′-(hexafluoroisopropylidene)diphthalic anhydride (6FDA) and 9,9-bis(trifluoromethyl)-2,3,6,7-xanthenetetracarboxylic dianhydride.

In one embodiment, additional dianhydrides for forming the polyimide can include 1,2,5,6-naphthalenetetracarboxylic dianhydride, 1,4,5,8-naphthalenetetracarboxylic dianhydride, 2,3,6,7-naphthalenetetracarboxylic dianhydride, bicyclo-[2,2,2]-octen-(7)-2,3,5,6-tetracarboxylic-2,3,5,6-dianhydride, cyclopentadienyltetracarboxylic dianhydride, ethylenetetracarboxylic dianhydride, pyromellitic dianhydride (PMDA), tetrahydrofurantetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, additional dianhydrides for forming the polyimide can include an alicyclic dianhydride, such as cyclobutane-1,2,3,4-tetracarboxylic diandydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c:4,5-cldifuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride.

In one embodiment, a polyimide is derived from 100 mole % pyromellitic dianhydride (PMDA) and 100 mole % 4,4′-diaminodiphenylether (ODA). In one embodiment a polyimide can have a weight-average molecular weight (Mw) of 100,000 daltons or more, 150,000 daltons or more, 200,000 daltons or more, or 250,000 daltons or more.

### Imidization Catalysts

In one embodiment, an imidization catalyst (sometimes called an “imidization accelerator”) can be used as a conversion chemical that can help lower the imidization temperature for forming the polyimide and shorten the imidization time. The polyamic acid casting solutions of the present invention comprises both a polyamic acid solution combined with some amount of conversion chemicals. The conversion chemicals found to be useful in the present invention include, but are not limited to, (i) one or more dehydrating agents and/or co-catalysts, such as, aliphatic acid anhydrides (acetic anhydride, trifluoroacetic anhydride, propionic anhydride, monochloroacetic anhydride, bromo adipic anhydride, etc.) and aromatic acid anhydrides; and (ii) one or more imidization catalysts, such as, aliphatic tertiary amines (triethylamine, etc.), aromatic tertiary amines (dimethylaniline, N,N-dimethyl benzylamine, etc.) and heterocyclic tertiary amines (pyridine, alpha-, beta-, gamma-picoline, 3,5-lutidine, 3,4-lutidene, isoquinoilne, etc.) and guanidines (e.g. tetramethylguanidine). In one embodiment, an imidization catalyst does not include a diazole. Other useful dehydrating agents can include diacetyl oxide, butyryl oxide, benzoyl oxide, 1,3-dichlorohexyl carbodiimide, N, N-dicyclohexyl carbodiimide, benzenesulfonyl chloride, thionyl chloride and phosphorus pentachloride. In some embodiments, the dehydrating agent can also act as a catalyst to enhance the reaction kinetics for the imidization. The anhydride dehydrating material is typically used in a slight molar excess of the amount of amide acid groups present in the polyamic acid solution. In one embodiment, the amount of dehydrating agent used is typically about 2.0 to 4.0 moles per equivalent of the polyamic acid formula unit. Generally, a comparable amount of tertiary amine catalyst is used. The ratio of these catalysts and their concentration in the polyamic acid solution will influence imidization kinetics and the film properties. Polyimide films having substantially chemically converted polyimide can have imidization catalysts present in the polyimide film in an amount in the range of from 1 part per billion (ppb) to 1 wt %, from 10 ppb to 0.1 wt %, or from 100 ppb to 0.01 wt %.

### Corona Resistant Composite Fillers

The polyimide film of the present disclosure comprises an electrically insulative, corona resistant composite filler. In one embodiment, a corona resistant composite filler can have an organic component and an inorganic ceramic oxide component, wherein a weight ratio of the organic component to the inorganic ceramic oxide component is from 0.01:1 to 1:1. In some embodiments, the weight ratio of the organic component to the inorganic ceramic oxide component can be in a range between (and optionally including) any two of the following numbers: 0.01:1, 0.05:1, 0.1:1, 0.2:1, 0.3:1, 0.4:1, 0.5:1, 0.6:1, 0.7:1, 0.8:1, 0.9:1 and 1:1. In one embodiment, at least a portion of the organic component can include an organo-siloxane moiety or an organo-metaloxane moiety (e.g., organozirconate, organotitanate, organoaluminate).

In one embodiment, the inorganic ceramic oxide component can include silica, alumina, titania, zirconia or mixtures thereof. In one embodiment, the inorganic ceramic oxide component includes silica, alumina or a mixture thereof. In one embodiment, the inorganic ceramic oxide component is fumed alumina.

In one embodiment, the organic component of the corona resistant composite filler material is chosen primarily to provide or improve dispersability of the corona resistant composite filler material into a particular solvated polymer matrix or polymer matrix precursor. In some embodiments, the organic component of the corona resistant composite filler material is chosen to reduce the moisture absorption on the inorganic ceramic oxide component. Ordinary skill and experimentation may be necessary in optimizing the organic component for any particular solvent system selected. In some embodiments, the organo-siloxane moiety is n-octyl silane, or any of its structural isomers. In some embodiments, the corona resistant composite filler is an inorganic ceramic oxide without an organic component. In another embodiment, the organic component is a coating on the inorganic ceramic oxide component. The organic component may or may not cover the entire surface of the inorganic ceramic oxide component.

In one embodiment, the electrically insulative, corona resistant composite filler is present in an amount between and including any two of the following numbers: 5, 10, 15, 20, 25 and 30 weight percent, based upon the total weight of the polyimide film. In one embodiment, the corona resistant composite filler is present in an amount in a range of from 5 to 30, 5 to 25 or 5 to 20 weight percent, based upon the total weight of the polyimide film.

In one embodiment, the corona resistant composite filler can have a median particle size of from 0.1 to 5 μm, wherein at least 80, 85, 90, 92, 94, 95, 96, 98, 99 or 100 percent of the dispersed corona resistant composite filler is within the above defined size range. Median particle size can be measured using a Horiba LA-930 particle size analyzer (Horiba Instruments, Inc., Irvine, CA). DMAc can be used as the carrier fluid. In some embodiments, the corona resistant composite filler is a nanofiller. The term “nanofiller” is intended to mean a filler with at least one dimension less than 1000 nm, i.e., less than 1 μm.

In one embodiment, the polyimide film additionally includes a dispersing agent. In some embodiments, the polyimide film additionally includes a dispersing agent in an amount in a range of from 1 to 100 weight percent based on the weight of the inorganic ceramic oxide component. In some embodiments, the dispersing agent is selected from the group consisting of phosphated polyethers, phosphated polyesters, and mixtures thereof. In another embodiment, the dispersing agent is an alkylolammonium salt of a polyglycol ester. In another embodiment, the dispersing agent is selected from the group consisting of Disperbyk 180, an alkylolammonium salt of a polyglycol ester, Disperbyk 111, a phosphated polyester, Byk W-9010, a phosphated polyester or mixtures there of (all available from Byk-Chemie GmBH, Wesel, Germany). In another embodiment, the dispersing agent is Solplus D540, a phosphated ethylene oxide/propylene oxide copolymer available from Lubrizol, Inc., Cleveland, OH. In yet another embodiment, the dispersing agent is a mixture of any of the above dispersing agents. In some embodiments, the dispersing agent is an aromatic polyamic acid or aromatic polyimide. In another embodiment the dispersing agent is a polyalkylene ether such as polytetramethylene glycol and polyethylene glycol. Typically, aromatic polyamic acid or aromatic polyimide have high temperature stability and thus mostly would remain in the polyimide. Whereas dispersing agents such as polyalkylene ethers have a low temperature stability and would mostly decompose or be burned off at the temperatures used in the imidization process.

### Polyimide Films

In one embodiment, a polyimide film can be produced by combining a diamine and a dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution, and/or the polyamic acid solution, are combined with conversion chemicals like: (i) one or more dehydrating agents, such as, aliphatic acid anhydrides (acetic anhydride, etc.) and/or aromatic acid anhydrides; and (ii) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0 to 4.0 moles per equivalent (repeat unit) of polyamic acid. Generally, a comparable amount of tertiary amine catalyst is used. Fillers, dispersed or suspended in solvent as described above, are then added to the polyamic acid solution.

In one embodiment, the polyamic acid solution is dissolved in an organic solvent at a concentration from about 5.0 or 10 percent to 15, 20, 25, 30, 35 or 40 percent by weight. In one embodiment, a slurry comprising a filler is prepared, where the slurry has a solids content in a range of from 0.1 to 70, from 0.5 to 60, from 1 to 55, from 5 to 50, or from 10 to 45 percent by weight. The slurries may or may not be milled using a ball mill to reach the desired particle size. The slurries may or may not be filtered to remove any residual large particles. A polyamic acid solution can be made by methods well known in the art. The polyamic acid solution may or may not be filtered. In some embodiments, the solution is mixed in a high shear mixer with the filler slurry. When a polyamic acid solution is made with a slight excess of diamine, additional dianhydride solution may or may not be added to increase the viscosity of the mixture to the desired level for film casting. The amount of the polyamic acid solution, and filler slurry can be adjusted to achieve the desired loading levels in the cured film. In some embodiments, the mixture is cooled below 10° C. and mixed with conversion chemicals prior to casting.

The solvated mixture (the polyamic acid casting solution) can then be cast or applied onto a support, such as an endless belt or rotating drum, to give a partially imidized gel film. Alternatively, it can be cast on a polymeric carrier such as PET, other forms of Kapton® polyimide film (e.g., Kapton® HN or Kapton® E films) or other polymeric carriers. The gel film may be stripped from the drum or belt, placed on a tenter frame, and cured in an oven, using convective and radiant heat to remove solvent and complete the imidization to greater than 98% solids level. The film can then be separated from the support, oriented such as by tentering, with continued heating (drying and curing) to provide a substantially chemically converted polyimide film.

Useful methods for producing polyimide films can be found in U.S. Pat. Nos. 5,166,308 and 5,298,331, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals (catalysts) are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting another dianhydride component with another amine component to give a second polyamic acid. Then combining the amic acids in any one of a number of ways prior to film formation.

In one embodiment, filler is first dispersed in a solvent to form a slurry. The slurry is then dispersed in the polyamic acid solution. In one embodiment, the concentration of filler to polyimide (in the final film) is in a range of from 10 to 50 vol %, from 15 to 45 vol %, from 15 to 40 vol %, from 20 to 35 vol %, or from 25 to 30 vol %. In one embodiment, the concentration of filler to polyimide (in the final film) is at least 10, at least 15, at least 20, or at least 25 vol %. The composition of the cured film can be calculated from the composition of the components in the mixtures, excluding DMAc solvent (which is removed during curing) and accounting for removal of water during conversion of polyamic acid to polyimide.

In one embodiment, the filled polyamic acid casting solution is a blend of a polyamic acid solution and filler. In this casting solution, the filler is present in a concentration range from 0.1 to 70 vol %, from 1 to 60 vol %, from 2 to 50 vol %, from 5 to 45 vol %, or from 5 to 40 vol %. In one embodiment, the filler is first dispersed in the same polar aprotic solvent used to make the polyamic acid solution (e.g., DMAc). Optionally, a small amount of polyamic acid solution may be added to the filler slurry to increase the viscosity of the slurry. Optionally, a dispersant or dispersing agent may be added to aid in dispersion or alter the rheology of the slurry.

The filler may be blended into a particular solvated polymer matrix or polymer matrix precursor by using any commonly used technique such as batch mixing using solvent(s), dry mixing, or continuous mixing using solvent(s). Parameters such as order of raw material addition, mixing speed, shear rate, type of mixing blade (e.g., shear blade), mixing time, temperature, and pressure are known to affect the final degree of mixing between the filler and the matrix material.

In one embodiment, blending of the filler slurry with a polyamic acid solution to form the filled polyamic acid casting solution is done using high shear mixing. In this embodiment, if the filler is present beyond 50 volume percent in the final film, the film can be too brittle and may not be sufficiently flexible to form a freestanding, mechanically tough, flexible sheet.

In one embodiment, the casting solution can further comprise any one of a number of additives, such as processing aids (e.g., oligomers), antioxidants, light stabilizers, flame retardant additives, anti-static agents, heat stabilizers, ultraviolet absorbing agents or various reinforcing agents.

In some embodiments, a coextrusion process can be used to form a multilayer polyimide film with an inner core layer sandwiched between two outer layers. In this process, a finished polyamic acid solution is filtered and pumped to a slot die, where the flow is divided in such a manner as to form the first outer layer and the second outer layer of a three-layer coextruded film. In some embodiments, a second stream of polyimide is filtered, then pumped to a casting die, in such a manner as to form the middle polyimide core layer of a three-layer coextruded film. The flow rates of the solutions can be adjusted to achieve the desired layer thickness.

In some embodiments, the multilayer film is prepared by simultaneously extruding the first outer layer, the core layer and the second outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt. In one embodiment, the belt is then passed through a convective oven, to evaporate solvent and partially imidize the polymer, to produce a “green” film. The green film can be stripped off the casting belt and wound up. The green film can then be passed through a tenter oven to produce a fully cured polyimide film. In some embodiments, during tentering, shrinkage can be minimized by constraining the film along the edges (i.e., using clips or pins).

In one embodiment, the outer layers of the present invention can also be applied to the core layer during an intermediate manufacturing stage of making polyimide film such as to gel film or to green film.

When forming a polyimide film, the term “gel film” refers to a polyamic acid sheet, which is laden with volatiles, primarily solvent, to such an extent that the polyamic acid is in a gel-swollen, or rubbery condition, and may be formed in a chemical conversion process. The volatile content is usually in the range of 70 to 90% by weight and the polymer content usually in the range of 10 to 30% by weight of the gel film. The final film becomes “self-supporting” in the gel film stage. It can be stripped from the support on which it was cast and heated to a final curing temperature. The gel film generally has an amic acid to imide ratio between 10:90 and 50:50, most often 30:70.

The gel film structure can be prepared by the method described in U.S. Pat. No. 3,410,826. This patent discloses mixing a chemical converting agent and a catalyst, such as a lower fatty acid anhydride and a tertiary amine, into the polyamic-acid solution at a low temperature. This is followed by casting the polyamic-acid solution in film-form, onto a casting drum. The film is mildly heated after casting, at for example 100° C., to activate the conversion agent and catalyst in order to transform the cast film to a polyamic acid/polyimide gel film.

Another type of polymer film is a “green film” which, for a polyimide film, is partially polyamic acid and partially polyimide, and may be formed in a thermal conversion process. Green film contains generally about 50 to 75% by weight polymer and 25 to 50% by weight solvent. Generally, it should be sufficiently strong to be substantially self-supporting. Green film can be prepared by casting the polyamic acid solution into film form onto a suitable support such as a casting drum or belt and removing the solvent by mild heating at up to 150° C. A low proportion of amic acid units in the polymer, e.g., up to 25%, may be converted to imide units.

Application of the polyimide films of the present invention can be accomplished in any number of ways. Such methods include using a slot die, dip coating, or kiss-roll coating a film followed by metering with doctor knife, doctor rolls, squeeze rolls, or an air knife. The coating may also be applied by brushing or spraying. By using such techniques, it is possible to prepare both one and two-sided coated laminates. In preparation of the two-side coated structures, one can apply the coatings to the two sides of a polymer either simultaneously or consecutively before going to the curing and drying stage of the polymer.

The electrically insulative, corona resistant composite filler (dispersion or colloid thereof) can be added at several points in the polyimide film preparation. In one embodiment, the colloid or dispersion is incorporated into a prepolymer having a Brookfield solution viscosity in the range of about 50-100 poise at 25° C. “Prepolymer” is intended to mean a lower molecular weight polymer, typically made with a small stoichiometric excess (about 2-4%) of diamine monomer (or excess dianhydride monomer). In an alternative embodiment, the colloid or dispersion can be combined with the monomers directly, and in this case, polymerization occurs with the filler present during the reaction. In another embodiment, the colloid or dispersion can be combined with the “finished”, high viscosity polyimide. The monomers may have an excess of either monomer (diamine or dianhydride) during this “in situ” polymerization. The monomers may also be added in a 1:1 ratio. In the case where the monomers are added with either the amine (case i) or the dianhydride (case ii) in excess, increasing the molecular weight (and solution viscosity) can be accomplished, if necessary, by adding incremental amounts of additional dianhydride (case i) or diamine (case ii) to approach the 1:1 stoichiometric ratio of dianhydride to amine.

The thickness of the polyimide film may be adjusted, depending on the intended purpose of the film or final application specifications. In one embodiment, the polyimide film has a total thickness in a range of from 2 to 300 μm, from 5 to 200 μm, from 10 to 150 μm, from 20 to 100 μm, or from 20 to 80 μm.

### Fluoropolymer Coatings

In one embodiment, the polyimide film having an electrically insulative, corona resistant composite filler has a first fluoropolymer coating adhered to a first side of the polyimide film and a second fluoropolymer coating adhered to a second side of the polyimide film. One fluoropolymer coating is used to bond the polyimide film to a metal layer or wire, such as a stranded conductor. The other fluoropolymer coating is used to bond the polyimide film to an outer wrap, such as a fluoropolymer tape.

In one embodiment, a base film tape includes the polyimide film having first and second fluoropolymer coatings. In one embodiment the base film tape can be used as an inner wrap for an electrically insulated wire or cable including a stranded conductor. In one embodiment, the base film tape has a thickness in a range of from 25 μm to 40 μm as measured in the unwrapped state.

In one embodiment, fluoropolymer coatings comprise fluoropolymers selected from the group consisting of tetrafluoroethylene-hexafluoropropylene copolymer (FEP), perfluoro alkoxy resin (PFA), polytetrafluoroethylene (PTFE) or mixtures thereof. In one embodiment, a fluoropolymer coating comprises FEP in an amount in a range of from 65 to 100 weight percent based on the total weight of the fluoropolymer coating. In one embodiment, the fluoropolymer coating comprises FEP in an amount between (and optionally including) any two of the following numbers: 65, 70, 75, 80, 85, 90, 95 and 100 weight percent based on the total weight of the fluoropolymer coating. In one embodiment, the first fluoropolymer coating, the second fluoropolymer coating, or both the first and second fluoropolymer coatings are in direct contact with the polyimide film, such that there are no intervening layers between the fluoropolymer coatings and the polyimide film. In one embodiment, the fluoropolymer coating comprises 100 weight percent FEP. In one embodiment, the fluoropolymer of the first fluoropolymer coating and the fluoropolymer of the second fluoropolymer coating are each individually not crosslinked. In one embodiment, the first fluoropolymer coating and the second fluoropolymer coating are the same or different.

The fluoropolymer coating will generally have a thickness in a range between (and optionally including) any two of the following numbers: 0.25, 0.3, 0.4, 0.5, 0.6, 0.7, 0.8, 0.9, 1.0, 1.25, 1.5, 1.75, 2, 3, 4, 5, 10, 11, 12, 13, 14, 15, 16, 17, 18, 19, 20, 21, 22, 23, 24 and 25 μm. A useful thickness range is oftentimes in a range of from about 0.75 μm to 2.5 μm (generally in the range of about 0.03 to about 0.10 mils). In practice, the desired thickness can depend upon the specifications, particularly for military or commercial aircraft applications.

In some embodiments, the fluoropolymer coating may be applied to the polyimide film by, but not limited to, solution coating, colloidal dispersion coating or lamination.

The polyimide film may have its surface modified to improve adhesion to other layers, such as the fluoropolymer coating. Examples of useful surface modification are, but are not limited to, corona treatment, plasma treatment under atmospheric pressure, plasma treatment under reduced pressure, treatment with coupling agents like silanes and titanates, sandblasting, alkali-treatment, and acid-treatment.

The fluoropolymer coating of the present disclosure may comprise flame retardants and thermally conductive fillers, as well as fillers to tailor opacity, color and the rheology of the fluoropolymer coating.

In some embodiments, the fluoropolymer coating may contain a silane of the structure R¹ₘSi[OR²]₄₋ₘ with m being 0, 1, 2, or 3. R² is a C1-C4 alkyl group or a C1-C4 acyl group. R1 is a is a C1-C20 alkyl, C6-C30 aryl group, or a C5-C20 aliphatic group, each of which can optionally contain one or more heteroatoms as substituents. The term “one or more heteroatoms”, as used herein, refers to having one or more of: (1) a halogen, such as fluorine; (2) an ester group, such as an acrylate group, a methacrylate group, an amine group, an imine group, a fumarate group, and a maleate group; (3) a urethane group; and (4) a vinyl ether group.

In some embodiments, the fluoropolymer coating may contain an inorganic filler such as silica, alumina, titania, and/or zirconia. The filler may be same or different as the one present in the polyimide film. The filler may be present in a range of from 1 to 10 wt % relative to the dry weight of the coating. If more than one fluoropolymer coating is present on a polyimide film, then each fluoropolymer coating may independently be filled or unfilled.

In some embodiments, the thickness of a fluoropolymer coating does not exceed the thickness of the polyimide film. In one embodiment, the thickness ratios of the fluoropolymer coatings to the polyimide film are each individually less than 0.5:1, or less than 0.4:1, or less than 0.3:1 or less than 0.2:1. In one embodiment, a thickness ratio of the first fluoropolymer coating to the polyimide film and a thickness ratio of the second fluoropolymer coating to the polyimide film are each individually in a range of from 0.01:1 to 0.5:1, or 0.03:1 to 0.3:1 or 0.05:1 to 0.2:1.

### Fluoropolymer Tapes

In one embodiment, a fluoropolymer tape comprises polytetrafluoroethylene (PTFE). In one embodiment, a fluoropolymer tape comprises a blend of FEP and perfluoro alkoxy resin (PFA), a blend of FEP and PTFE or a blend of FEP, PFA and PTFE.

### Electrically Insulated Wires and Cables

In one embodiment, an electrically insulated wire or cable having an electrically insulative, corona resistant composite filler is useful as a wire wrap. In some embodiments, the wire wrap may contain additional layers, such as adhesive layers or scrap abrasion resistant layers. Films or sheets of wire wrap can be slit into narrow widths to provide tapes. These tapes can then be wound around an electrical conductor in spiral fashion or in an overlapped fashion. The amount of overlap can vary, depending upon the angle of the wrap. In one embodiment, the amount of overlap does not exceed 66%. The tension employed during the wrapping operation can also vary widely, ranging from just enough tension to prevent wrinkling, to a tension high enough to stretch and neck down the tape. Even when the tension is low, a snug wrap is possible since the tape will often shrink under the influence of heat during any ensuing heat-sealing operation. Heat-sealing of the tape can be accomplished by treating the tape-wrapped conductor at a temperature and time sufficient to fuse the bonding layer to the other layers in the composite. The heat-sealing temperature required ranges generally from 240, 250, 275, 300, 325 or 350° C. to 375, 400, 425, 450, 475 or 500° C., depending upon the insulation thickness, the gauge of the metal conductor, the speed of the production line and the length of the sealing. In one embodiment, the wrapped wire is rated for voltages up to 600 V and has properties meeting or exceeding those listed in SAE AS22579™, particularly AS22579™/80-82 and AS22579™/86-92.

In one embodiment, a cross section of a wrapped wire will typically show a certain contact length between insulation, such as an inner wrap, and individual strands of the wire. The term “contact length”, as used herein, refers to the percentage of the length of the inner wrap that is in intimate contact with the outer surface of the stranded conductor. In the case of a single-strand wire (i.e., not a stranded conductor), the contact length is essentially 100%. For a stranded conductor having fewer than 100 strands, the contact length will be in a range of from 15 to 69%, while for a stranded conductor having more than 100 strands, the contact length will be in a range of from 15 to 79%. For a concentric multi-stranded conductor, the contact length will be in a range of from 10 to 70% or from 12 to 60%. The specific contact length will depend on a variety of factors, such as nominal wire size of the multi-stranded wire and the nominal wire size of the individual strands, the chemical nature of polyimide as well as the fluoropolymer applied to the polyimide film and facing the individual strands, the temperature and pressure profiles applied during the wire wrapping process, the line speed, as well as the amount of overlap and the tension applied to the tape during the wrapping process. Specific mechanical properties of the polyimide such as its mechanical response under compressive loads are expected to influence the resulting contact length under a given set of specific processing values (temperature, line speed, pressure etc.). It is known that incorporation of filler materials into a polyimide film can change its mechanical response under compressive loads.

In one embodiment, a wrapped stranded conductor will contain void space inside the wrapped wire which can be visualized in a cross section of the construction. “Void space” is intended to mean space inside the boundary formed by the wrap, such as an inner wrap, that is not occupied by the conductor material, such as a stranded conductor, or any other solid material. In one embodiment, the void space is occupied by air. The percentage of void space inside a wrapped wire having a stranded conductor is in a range of from 2 to 43%, based on the total space available inside the wrap. The specific amount of void space present will depend on a variety of factors similar to those affecting the contact length.

One benefit of using a corona-resistant insulating film on a multi-stranded single conductor is that the resulting construction has a significantly thinner overall diameter compared to similarly performing solutions that use a non-corona-resistant insulating film, which overall enables savings in both occupied space and weight in any given application.

The advantageous properties of this invention can be observed by reference to the following examples that illustrate, but do not limit, the invention. All parts and percentages are by weight unless otherwise indicated.

### EXAMPLES

### Test Methods

### Thickness

Thickness of the film samples was determined following ASTM D374 using a pressure setting of 25 psi and an anvil size of 0.25″ diameter.

### Voltage Endurance

Voltage endurance was determined following ASTM D2275 using 0.5″ diameter electrodes and reporting the median failure time out of a sample set of 9 specimens. Testing conditions include an applied voltage of 1.4 kV at 1 kHz. Samples were wound with 10 turns and had a 1 lbs weight attached to them.

### Scrape Abrasion

A G.E. Repeated Scrape Abrasion Tester, Wellman Thermal Systems Catalog No. 158L238G1 was used with a stainless-steel scraper having a radial edge of 0.6 mm. A weight of 1000 g rested on the scraper (including the weight of the arm). The specimen to be tested was clamped down in the test apparatus to prevent movement in the lengthwise direction. A travel distance of 9.8 mm was used at a rate of 56 cycles per minute. The test was stopped when electrical contact was made between the weighted scraper and the bared conductor contained within the specimen, and the achieved number of cycles noted. The average number of cycles for 5 locations tested on the same specimen is reported per sample. The wire was moved 100 mm lengthwise and rotated by 90 degrees between testing locations.

### Dynamic Cut-Through

Determined following ASTM D-3032. The average of 8 independent samples is reported.

### Example 1

For Example 1 (E1), a 1 mil (25.4 μm) polyimide film derived from pyromellitic dianhydride (PMDA) and 4,4′-diaminodiphenylether (ODA) and having 17 wt % Al₂O₃ filler was dispersion coated on both sides with a fluoropolymer coating of tetrafluoroethylene-hexafluoropropylene copolymer (FEP) containing 5.6 wt % TiO₂ and 0.4 wt % silane (both based on the dry weight of the coating). The dry thickness of the FEP coating was 0.1 mil (2.54 μm) on each side of the polyimide film. The 1.2 mil (30.5 μm) coated film was slit to form a base film tape with a width of 5.5 mm and wrapped around a 20-gage unilay nickel-coated copper alloy stranded conductor (Fisk Alloy Inc., Hawthorne, NJ). The 19/32 unilay stranded conductor had a diameter of 37.6 mil (0.955 mm), and the base film tape was wrapped with a 53% overlap to form an inner wrap around the stranded conductor. A 2 mil (50.8 μm) thick PTFE fluoropolymer tape (available from 3M, St. Paul, MN) with a width of 6.35 mm was used as an outer wrap and had a 53% overlap.

### Comparative Example 1

For Comparative Examples 1 (CE1), a 0.65 mil (16.5 μm) polyimide film derived from pyromellitic dianhydride (PMDA) and 4,4′-diaminodiphenylether (ODA) and para-phenylenediamine (PPD) (weight ratio of ODA to PPD 2.777:1) was dispersion coated on both sides with a fluoropolymer coating mixture of tetrafluoroethylene-hexafluoropropylene copolymer (FEP) and PTFE (25:75 w/w) containing 6.5 wt % TiO₂ and 0.4 wt % silane (both based on the dry weight of the coating). The dry thickness of the fluoropolymer coating was 0.1 mil (2.54 μm) on the first side of the polyimide film, and 0.5 mil on the second side of the polyimide film. The 1.2 mil (30.5 μm) coated film was slit to form a base film tape with a width of 5.5 mm and wrapped around a 20-gage unilay nickel-coated copper alloy stranded conductor. The base film tape was wrapped with a 53% overlap to form an inner wrap around the stranded conductor and the same 2 mil (50.8 μm) thick PTFE fluoropolymer tape of E1 was used as an outer wrap and also had a 53% overlap.

### Comparative Example 2

For Comparative Examples 2 (CE2), a 0.65 mil (16.5 μm) polyimide film derived from pyromellitic dianhydride (PMDA) and biphenyl-tetracarboxylic acid dianhydride (BPDA) (weight ratio of PMDA to BPDA 1.074:1) and 4,4′-diaminodiphenylether (ODA) and para-phenylenediamine (PPD) (weight ratio of ODA to PPD 1.24:1) was dispersion coated on the first side with a fluoropolymer coating of tetrafluoroethylene-hexafluoropropylene copolymer (FEP) with a dry thickness of 0.1 mil, and then dispersion coated on the second side with a fluoropolymer coating mixture of tetrafluoroethylene-hexafluoropropylene copolymer (FEP) and PTFE (25:75 w/w) having 6.5 wt % TiO₂. The dry thickness of the fluoropolymer coating was 0.1 mil (2.54 μm) on the first side of the polyimide film, and 0.5 mil on the second side of the polyimide film. The 1.2 mil (30.5 μm) coated film was slit to form a base film tape with a width of 5.5 mm and wrapped around a 20-gage unilay nickel-coated copper alloy stranded conductor. The base film tape was wrapped with a 53% overlap to form an inner wrap around the stranded conductor and the same 2 mil (50.8 μm) thick PTFE fluoropolymer tape of E1 was used as an outer wrap and also had a 53% overlap.

### Comparative Example 3

For Comparative Examples 3 (CE3), a 20-gage unilay nickel-coated copper alloy stranded conductor carrying a 48.8 um thick crosslinked ETFE insulating layer was used. XL-ETFE is processed following the same techniques as those followed to develop other thermoplastics (e.g., heat sealing, thermoforming, laminating, and die-cutting). XL-ETFE, when applied as wire insulation, has typical properties as described in SAE Standard AS22759™, particularly, AS22759™/32-35 and AS22759™/41-46. Stranded wire insulated with XL-ETFE is available from Allied Wire and Cable (Collegeville, PA), Mouser Electronics (Mansfield, TX), Marmon Aerospace & Defense, LLC (Naples, FL) and TE Connectivity (Switzerland). Most ETFE grades are rated for continuous use at 150° C.

Examples are summarized in Table 1 below. The electrically insulated wire of E1 is far superior to the those made using typical wrap structure (CE1-CE3) of comparable thicknesses.

TABLE 1

| Exam- | Scrape abrasion | Dynamic cut | Voltage endurance |
|---|---|---|---|
| ple | (Number of Cycles) | through (Newtons) | (Hours to Failure) |
| E1 | 702 | 91.8 | 147.6 |
| CE1 | 150 | 58.9 | 7.1 |
| CE2 | 206 | 77.5 | 5.4 |
| CE3 | 491 | 71.6 | 58.2 |

What is claimed is:

1. An electrically insulated wire or cable comprising:
a stranded conductor;
an inner wrap around the stranded conductor, the inner wrap comprising a base film tape, wherein the base film tape comprises:
a polyimide film having an electrically insulative, corona resistant composite filler;
a first fluoropolymer coating adhered to a first side of the polyimide film; and
a second fluoropolymer coating adhered to a second side of the polyimide film; and
an outer wrap around the inner wrap, the outer wrap comprising a fluoropolymer tape, wherein the electrically insulated wire or cable has a void space in a range of from 2 to 43%, based on the total space available inside the inner wrap.

2. The electrically insulated wire or cable of claim 1, wherein the stranded conductor comprises coated copper wire selected from the group consisting of nickel-coated copper alloy wire, tin-coated copper alloy wire and silver-coated copper alloy wire.

3. The electrically insulated wire or cable of claim 1, wherein the electrically insulative, corona resistant composite filler is present in an amount in a range of from 5 to 30 weight percent, based on the total weight of the polyimide film.

4. The electrically insulated wire or cable of claim 1, wherein the first fluoropolymer coating and the second fluoropolymer coating each individually comprises a fluoropolymer selected from the group consisting of tetrafluoroethylene-hexafluoropropylene copolymer, perfluoro alkoxy resin, polytetrafluoroethylene or a mixture thereof.

5. The electrically insulated wire or cable of claim 4, wherein the fluoropolymer of the first fluoropolymer coating and the fluoropolymer of the second fluoropolymer coating are each individually not crosslinked.

6. The electrically insulated wire or cable of claim 1, wherein the first fluoropolymer coating and the second fluoropolymer coating are the same or different.

7. The electrically insulated wire or cable of claim 1, wherein the fluoropolymer tape comprises polytetrafluoroethylene.

8. The electrically insulated wire or cable of claim 1, wherein the base film tape has a thickness in a range of from 25 μm to 40 μm as measured in the unwrapped state.

9. The electrically insulated wire or cable of claim 1, wherein the stranded conductor has less than 100 strands and a contact length between the inner wrap and the stranded conductor is in a range of from 15 to 69%.

10. The electrically insulated wire or cable of claim 1, wherein the stranded conductor has more than 100 strands and a contact length between the inner wrap and the stranded conductor is in a range of from 15 to 79%.

11. The electrically insulated wire or cable of claim 1, wherein the stranded conductor is a concentric multi-stranded conductor and has a contact length between the inner wrap and the stranded conductor is in a range of from 10 to 70%.

12. The electrically insulated wire or cable of claim 1, wherein the electrically insulative, corona resistant composite filler comprises an organic component and an inorganic ceramic oxide component.

13. The electrically insulated wire or cable of claim 12, wherein the organic component is an organo-siloxane moiety or an organo-metaloxane moiety.

14. The electrically insulated wire or cable of claim 12, wherein the inorganic ceramic oxide component is selected from the group consisting of silica, alumina, titania, zirconia and mixtures thereof.

15. The electrically insulated wire or cable of claim 12, wherein a weight ratio of the organic component to the inorganic ceramic oxide component is in a range of from 0.01:1 to 1:1.

16. The electrically insulated wire or cable of claim 1, wherein a thickness ratio of the first fluoropolymer coating to the polyimide film and a thickness ratio of the second fluoropolymer coating to the polyimide film are each individually in a range of from 0.01:1 to 0.5:1.

17. The electrically insulated wire or cable of claim 1, wherein the amount of overlap of the inner wrap does not exceed 66%.
